(19) United States
(12) Patent Application Publication
(10) Pub. No.: US 2016/0031040 A1
(43) Pub. Date: Feb. 4, 2016

(54) LASER CUTTING METHOD AND APPARATUS THEREOF

(71) Applicant: WECON AUTOMATION CORP., Hsinchu City (TW)

(72) Inventors: CHING TSUNG CHANG, Hsinchu City (TW); CHAO CHING WU, Hsinchu City (TW)

(21) Appl. No.: 14/551,002

(22) Filed: Nov. 22, 2014

(30) Foreign Application Priority Data
Jul. 29, 2014 (TW) 103125780

(51) Int. Cl. B23K 26/364; B23K 26/06; B23K 26/10; B23K 26/03

(52) U.S. Cl. CPC B23K 26/364; B23K 26/032; B23K 26/0643; B23K 26/0648; B23K 26/10

(57) ABSTRACT

The present invention relates to a laser cutting method and apparatus thereof. The method comprises the following steps of fixing a substrate to be cut on a base, processing a first alignment procedure via an image sensor, forming a first cutting channel on a first surface of the substrate by cutting the first surface via laser beams, flipping over the substrate to be cut and fixing the substrate on the base, processing a second alignment procedure via the image sensor, and forming a second cutting channel on a second surface of the substrate by cutting the second surface via laser beams. The method can achieve improvement to laser cutting quality and effectiveness of enhancing production.

### BACKGROUND OF THE INVENTION

1. Field of the Invention

The present invention relates to a laser cutting method and apparatus thereof, particularly with regard to a laser cutting method and apparatus thereof suitable for the technical field of substrate cutting.

2. The Related Arts

The traditional cutting practice of wafers is usually to use a diamond knife to mechanically cut out an individual die (chip) therefrom. Because the mechanical cutting process is very time consuming, mechanical cutting is also easy to cause damages on thin wafers, and thickness of the diamond knife tool has its own limitations, the above mentioned drawbacks inevitably cause a result that wafer reserved cutting space is too large, and wafer invalid area loss is also too large. As a result, the related die production is reduced and the die cost is significantly increased.

In recent years, because laser cutting technology has become more mature day by day, it gradually replaces the traditional mechanical cutting methods. The advantage of laser cutting is fast cutting and uneasy to cause mechanical damages to wafers with a brittle texture. Meanwhile, since laser beams can be focused onto a very small spot, a loss due to cutting areas can be effectively reduced during wafer cutting processing, and thus die production can be enhanced so as to effectively reduce cost of die production. Therefore, laser cutting has become an indispensable important role in the field of precision cutting, especially for semiconductor wafers.

However, problem of splattered slag generated during laser cutting and incapability to fully control cracks during laser cutting continues to affect production yield and reliability. In particular, it has difficulties for cutting of rigid substrates, or for substrate cutting adopting narrower cutting channels.

In view of the above problems, the named inventor(s) of the present invention makes painstaking efforts to research and study in cooperation with application of related technical theory and rules, a laser cutting method and apparatus thereof which can effectively improve the above mentioned drawbacks are finally proposed. Its double-sided laser cutting on substrates to be cut is able to achieve better cutting characteristics.

### SUMMARY OF THE INVENTION

The object of the present invention is to provide a laser cutting method. The method comprises the following steps of fixing a substrate to be cut on a base, processing a first alignment procedure via an image sensor, forming a first cutting channel on a first surface of the substrate by cutting the first surface via laser beams, flipping over the substrate to be cut and fixing the substrate on the base, processing a second alignment procedure via the image sensor, and forming a second cutting channel on a second surface of the substrate by cutting the second surface via the laser beams. The method can achieve improvement to laser cutting quality and effectiveness of enhancing production.

Technical means adopted in the present invention to achieve the above object of the present invention is to provide a laser cutting apparatus. The laser cutting apparatus comprises a base used to fix a substrate to be cut thereon, an image sensor disposed above the base and corresponding to the substrate, a laser generation unit disposed between the base and the image sensor to output laser beams, an optical component set disposed at an output side of the laser beams of the laser generation unit and a control unit disposed at one side of the base and electrically connected to the image sensor and the laser generation unit. The optical component set comprises a reflector and a focal convergent lens, and the reflector reflects the laser beams to the focal convergent lens and then the focal convergent lens outputs the laser beams to the substrate.

In an embodiment of the present invention, the base comprises a moving member, and the image sensor is connected to the moving member.

In an embodiment of the present invention, the image sensor is correspondingly equipped with a reflector, and the reflector reflects images of the substrate to the image sensor.

In an embodiment of the present invention, the base is a platform to be seen through, a second moving member is comprised and disposed below the base, and a second image sensor is disposed below the base. The second image sensor is connected to the second moving member, and the second image sensor is electrically connected to the control unit.

In an embodiment of the present invention, the base comprises a groove, and the substrate is placed in the groove.

In an embodiment of the present invention, the base comprises and is installed with fixing pieces, and the substrate is fixed between the fixing pieces and the base.

In order to more clearly describe the laser cutting method and apparatus thereof of the present invention, the present invention will be further explained via the following embodiments and the attached drawings.

### BRIEF DESCRIPTION OF THE DRAWINGS

FIG. 1 shows a schematic flow diagram of a laser cutting method in accordance with an embodiment of the present invention;

FIG. 2 shows a schematic side view of a laser cutting apparatus in accordance with an embodiment of the present invention;

FIG. 3 shows a schematic perspective exploded view of partial components of the laser cutting apparatus of FIG. 2 in accordance with an embodiment of the present invention;

FIG. 4 shows a schematic enlarged partial cross-sectional view of a substrate after cutting in accordance with an embodiment of the present invention; and

FIG. 5 shows a schematic enlarged cross-sectional view of the substrate for proceeding a splitting operation after cutting in accordance with an embodiment of the present invention.

### DETAILED DESCRIPTION OF PREFERRED EMBODIMENT

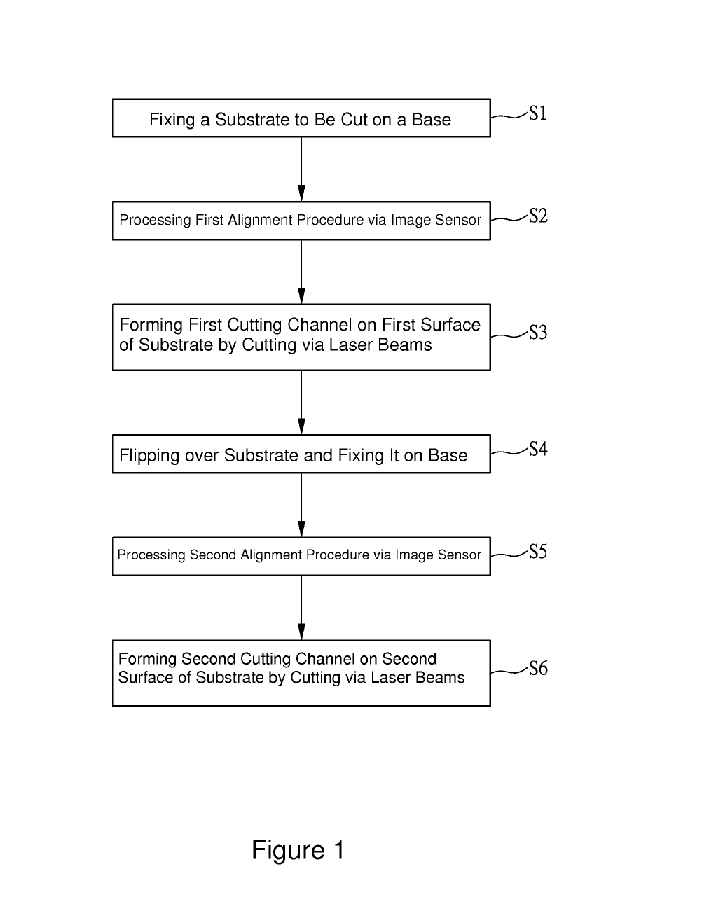

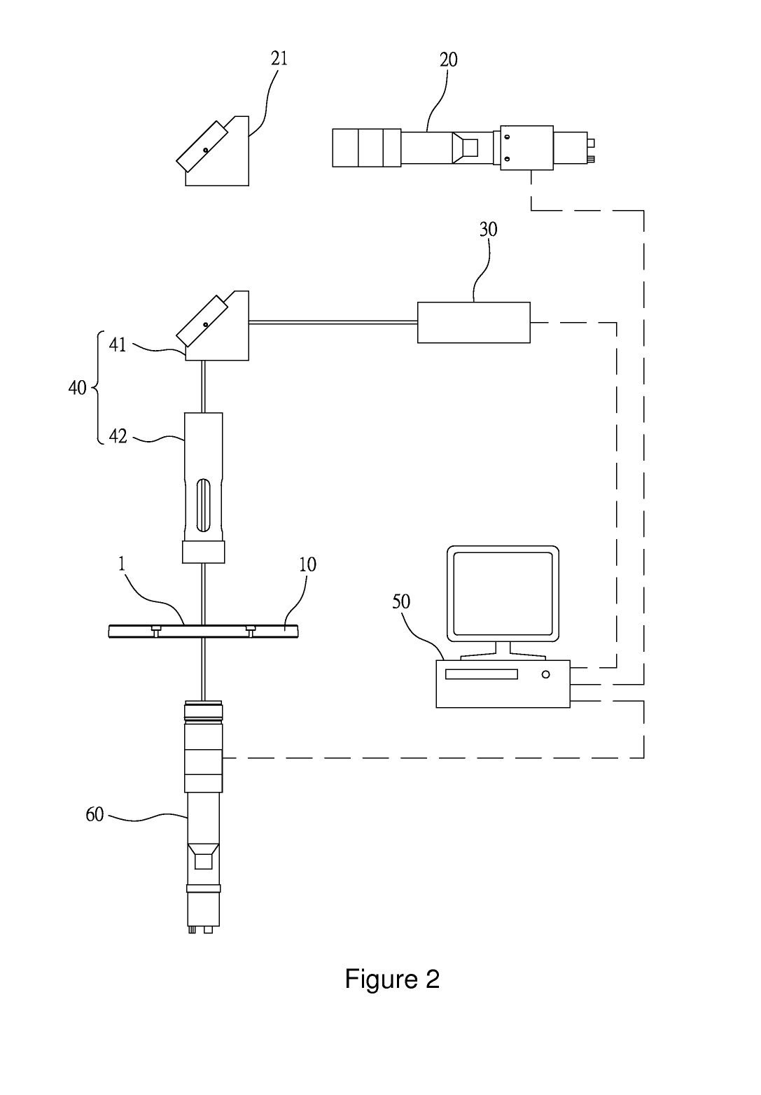

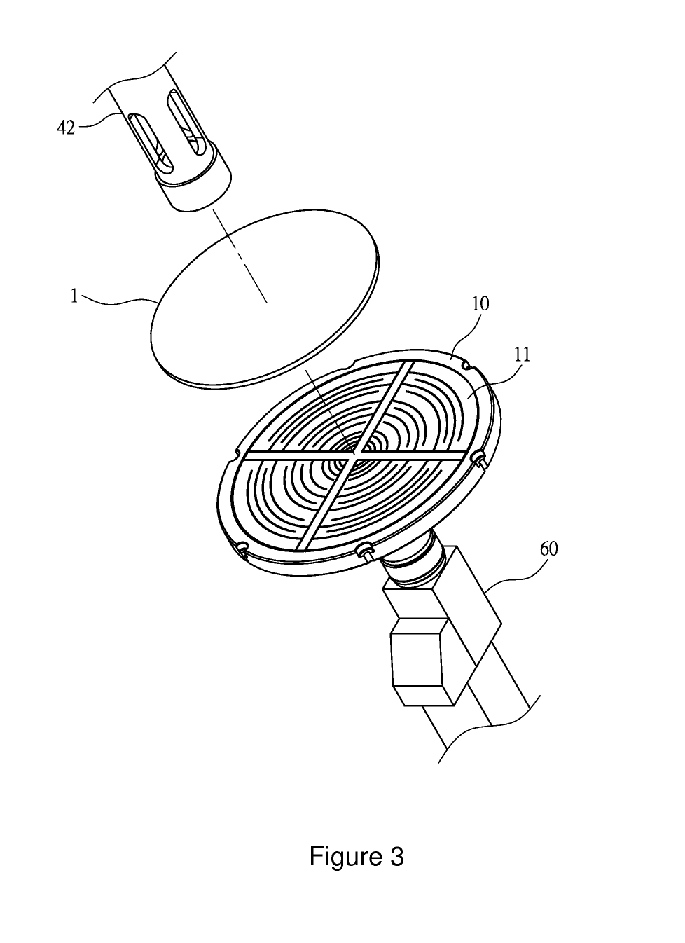

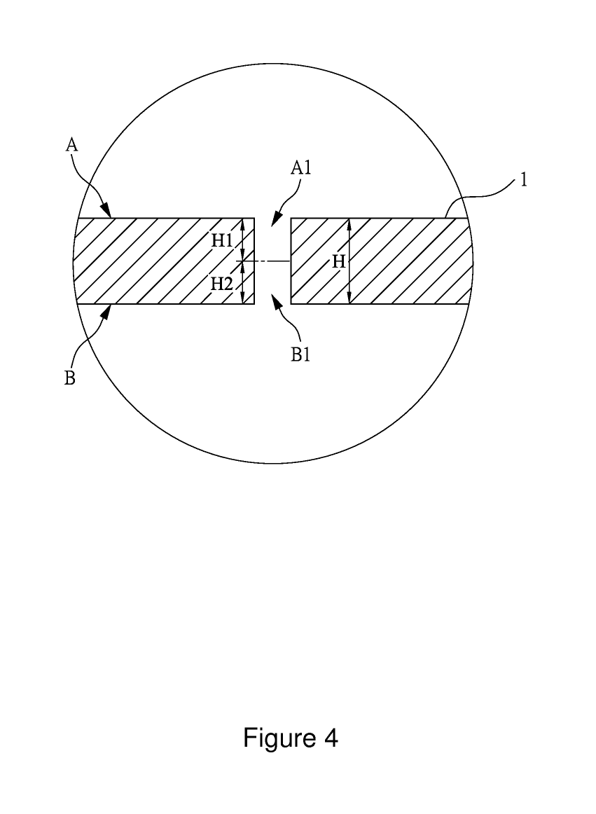

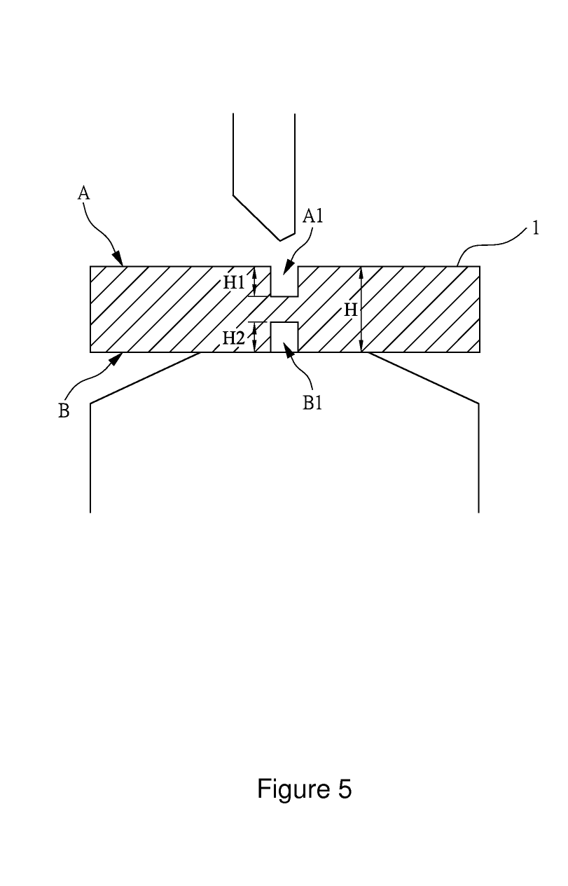

With reference to FIGS. 1 to 5, a laser cutting method in accordance with the present invention comprises the following steps. In step 51, a substrate 1 to be cut is fixed on a base 10. In step S2, a first alignment procedure is processed via an image sensor 20. In step S3, a first cutting channel A1 is formed on a first surface A of the substrate 1 by cutting the first surface via laser beams. In step S4, the substrate 1 to be cut is flipped over and is fixed on the base 10 again. In step S5, a second alignment procedure is processed via an image sensor 20. In step S6, a second cutting channel B1 is formed on a second surface B of the substrate 1 by cutting the second surface via laser beams. Herein, the first cutting channel A1 cut on the first surface A and the second cutting channel B1 cut on the second surface B correspond to each other. In other words, the first cutting channel A1 and the second cutting channel B1 are at the same position on two opposite surfaces A, B of the substrate 1 (located at either the same point or the same line), and the first surface A is a side of the substrate defined with a circuit pattern.

A laser cutting apparatus for accomplishing and processing the laser cutting method mentioned above comprises a base 10, an image sensor 20, a laser generation unit 30, an optical component set 40, and a control unit 50.

The base 10 can be moved along X-axis and Y-axis directions, respectively. The base 10 is equipped with a vacuum system in order to fix the substrate 1 onto the base 10 via vacuum suction. Preferably, the base 10 has a groove 11 slightly larger than the substrate 1 in order to place the substrate 1 in the groove 11. Alternatively, the base 10 comprises and is installed with fixing pieces, for example, a clamp or locking device, to fix the substrate 1 onto the base 10.

The image sensor 20 is preferably a charge-coupled device (abbreviated and known as “CCD”), and is disposed above the base 10. The image sensor 20 corresponds to the substrate 1 to aim at an alignment key defined on a cutting surface, for example, the alignment key is a cross pattern engraved and disposed at a side of the substrate 1. In the present embodiment, the base 10 comprises a moving member, and the image sensor 20 is connected to the moving member to move the image sensor 20 correspond to the base 10 along X-axis, Y-axis and Z-axis directions, respectively. The image sensor 20 is correspondingly equipped with a reflector 21, and the reflector 21 is used to reflect images of the substrate 1 to the image sensor 20.

The laser generation unit 30 is disposed between the base 10 and the image sensor 20, and the laser generation unit 30 is used to output laser beams. The laser generation unit 30 can be gas lasers such as helium argon lasers or carbon dioxide lasers, or solid state lasers such as sapphire lasers or ruby lasers, but the laser generation unit 30 is not limited to the above mentioned lasers.

The optical component set 40 is disposed at an output side of the laser beams of the laser generation unit 30. The optical component set 40 comprises a reflector 41 and a focal convergent lens 42, and the reflector 41 is used to reflect the laser beams from the laser generation unit 30 to the focal convergent lens 42 and then the focal convergent lens 42 outputs the laser beams to the substrate 1 to form cutting channels. Herein, the focal convergent lens 42 can be moved along a Z-axis direction.

The control unit 50, which can be a host computer and is equipped with a monitor, is disposed at one side of the base 10, and the control unit 50 is electrically connected to the image sensor 20 and the laser generation unit 30. In this way, bi-directional transmission of signals can be processed between the control unit 50, the image sensor 20 and the laser generation unit 30 so that to the control unit 50 can receive image signals of the image sensor 20, and send action signals to the laser generation unit 30 to output laser beams.

In the present embodiment, the base 10 is a platform to be seen through, for example, a platform made of tempered glasses or transparent plastics. Furthermore, the groove 11 of the base 10 can alternatively be a design of comprising a hollow part therein. A second moving member is disposed below the base 10, and a second image sensor 60 is also disposed below the base 10. The second image sensor 60 is connected to the second moving member, and the second image sensor 60 is electrically connected to the control unit 50.

The present embodiment is processed as follows. In step S1, the substrate 1 to be cut is fixed onto the base 10. The substrate 1 is made of ceramics, glass or quartz. The base 10 is equipped with the vacuum system in order to fix the substrate 1 onto the base 10 via vacuum suction. Alternatively, the base 10 comprises and is installed with fixing pieces, for example, a clamp or locking device, to fix the substrate 1 onto the base 10.

In step S2, the first alignment procedure is processed via the image sensor 20. The image sensor 20 is disposed above the base 10. The first surface A of the substrate 1 comprises an alignment key, for example, engraved cross patterns disposed at the side of the first surface A of the substrate 1. The first alignment procedure is practiced by aiming at the alignment key of the first surface A of the substrate 1 via the image sensor 20.

The control unit 50 receives the image signals of the image sensor 20, and sends the action signals to the laser generation unit 30 to output laser beams.

In step S3, the first cutting channel A1 is cut out on the first surface A of the substrate 1 by the laser beams. The required laser beams are output from the laser generation unit 30, and the laser generation unit 30 is disposed between the base 10 and the image sensor 20. The reflector 41 of the optical component set 40 reflects the laser beams to the focal convergent lens 42 and then the focal convergent lens 42 outputs the laser beams to the first surface A of the substrate 1 to cut out the first cutting channel A1.

In step S4, the substrate 1 to be cut is flipped over and fixed onto the base 10 again. By releasing vacuum of the base 10 (introducing gas/air to invalidate vacuum) and restarting the vacuum system after the substrate 1 is flipped over, the flipped-over substrate 1 is afresh fixed onto the base 10 via vacuum suction so as to fix the substrate 1 on the base 10 again. Alternatively, the substrate 1 can be released from the fixing pieces of the base 10 via manual operations or automatic operations, and the substrate 1 is fastened by the fixing pieces again after it is flipped over.

In step S5, the second alignment procedure is processed via the image sensor 20. The second surface B of the substrate 1 comprises an alignment key, for example, engraved cross patterns disposed at the side of the second surface B of the substrate 1. The second alignment procedure is practiced by aiming at the alignment key of the second surface B of the substrate 1 via the image sensor 20. Alternatively, the alignment key of the first surface A of the substrate 1 and the alignment key of the second surface B of the substrate 1 are the same alignment key, for example, they are the same cross hollow pattern defined in a same substrate position of the sides of the first surface A and the second surface B of the substrate 1 and used to cut through the substrate 1. Alternatively, the second alignment procedure is practiced by aiming at a shading area of the first cutting channel A1 cut on the first surface A of the substrate 1 via the image sensor 20 where the shading area is a shade revealing area of the first cutting channel A1 on the second surface B of the substrate 1. In the present embodiment, the base 10 is a platform to be seen through, and the second image sensor 60 is disposed below the base 10. The second alignment procedure is practiced by aiming at the first cutting channel A1 cut on the first surface A of the substrate 1 via the second image sensor 60.

In step S6, the second cutting channel B1 is cut out on the second surface B of the substrate 1 by the laser beams. The control unit 50 receives image signals of the second image sensor 60, and sends related action signals to the laser generation unit 30 for outputting laser beams. The reflector 41 reflects the laser beams to the focal convergent lens 42 and then the focal convergent lens 42 outputs the laser beams to the second surface B of the substrate 1 to cut out the second cutting channel B1.

The laser beams output by the laser generation unit 30 cut out the first cutting channel A1 having a first cutting depth H1 on the first surface A, and the laser beams output by the laser generation unit 30 cut out the second cutting channel B1 having a second cutting depth H2 on the second surface B. When a total depth of the first cutting depth H1 and the second cutting depth H2 is less than a thickness H of the substrate) , i.e., in step S6, after the second cutting channel B1 is cut out on the second surface B of the substrate 1 via the laser beams, the substrate 1 will not be broken thereat since the second cutting channel B1 and the first cutting channel A1 are spaced apart from each other by a predetermined distance. The substrate 1 will be treated with subsequent processing manufacturing procedures, such as splitting operations which are processed by utilizing a chopper above the substrate 1 to aim at the first cutting channel A1 cut out on the first surface A and to press downward against the substrate 1. The splitting operations will be repeatedly processed until the substrate 1 (wafer) are broken up from a whole into parts to form a plurality of sticks and dies (chips). In the present embodiment, the total depth of the first cutting depth H1 and the second cutting depth H2 is equal to the thickness H of the substrate 1, i.e., in step S6, after the second cutting channel B1 is cut out on the second surface B of the substrate 1 via the laser beams, the substrate 1 is broken thereat since the second cutting channel B1 and the first cutting channel A1 are spatially connected to each other. Besides, the first cutting depth H1 of the first cutting channel A1 is less than the second cutting depth H2 of the second cutting channel B1. As a result, situations that circuits defined on the first surface A of the substrate 1 become damaged due to splashed melt residues from laser cutting can be significantly improved, a preserved space for cutting can be reduced and a die amount of the substrate 1 can be increased.

The present invention is characterized as follows. A laser cutting apparatus in accordance with the present invention comprises a base 10, an image sensor 20, a laser generation unit 30, an optical component set 40 and a control unit 50. A laser cutting method in accordance with the present invention and proceeded by the laser cutting apparatus comprises the following steps of fixing a substrate 1 to be cut on the base 10, processing a first alignment procedure via the image sensor 20, forming a first cutting channel A1 on a first surface A of the substrate 1 by cutting the first surface A via laser beams, flipping over the substrate 1 to be cut and fixing the substrate 1 to be cut on the base 10, processing a second alignment procedure via the image sensor 20, and forming a second cutting channel B1 on a second surface B of the substrate 1 by cutting the second surface B via laser beams. The method can achieve improvement to laser cutting quality and effectiveness of enhancing production.

Although the preferred embodiments of the present invention are described as above, they are not intended to limit the present invention. Any person skilled in this art of the present invention can make some changes or improvements according to shapes, structures, features and inventive spirits as depicted in the above descriptions of the present invention without departing from the inventive spirit and scope of the present invention, and the changes or improvements are still covered within the inventive spirit of the present invention and the scope as defined in the following claims. Therefore, the patent claim scope of the present invention is defined by claims as appended in the specification of the present invention.

What is claimed is:

1. A laser cutting method, comprising:
fixing a substrate to be cut on a base;
processing a first alignment procedure via an image sensor;
forming a first cutting channel on a first surface of the substrate by cutting the first surface via laser beams;
flipping over the substrate to be cut and fixing the substrate to be cut on the base;
processing a second alignment procedure via the image sensor; and
forming a second cutting channel on a second surface of the substrate by cutting the second surface via laser beams.

2. The laser cutting method as claimed in claim 1, wherein the first cutting channel cut out on the first surface and the second cutting channel cut out on the second surface correspond to each other.

3. The laser cutting method as claimed in claim 1, wherein the laser beams cut out the first cutting channel having a first cutting depth on the first surface, and the laser beams cut out the second cutting channel having a second cutting depth on the second surface, a total depth of the first cutting depth and the second cutting depth is equal to a thickness of the substrate.

4. The laser cutting method as claimed in claim 3, wherein the first cutting depth of the first cutting channel is less than the second cutting depth of the second cutting channel.

5. The laser cutting method as claimed in claim 1, wherein the laser beams cut out the first cutting channel having a first cutting depth on the first surface, and the laser beams cut out the second cutting channel having a second cutting depth on the second surface, a total depth of the first cutting depth and the second cutting depth is less than a thickness of the substrate.

6. The laser cutting method as claimed in claim 5, wherein the first cutting depth of the first cutting channel is less than the second cutting depth of the second cutting channel.

7. The laser cutting method as claimed in claim 1, wherein the step of processing the first alignment procedure via the image sensor is practiced by aiming at an alignment key of the first surface of the substrate via the image sensor, and the step of processing the second alignment procedure via the image sensor is practiced by aiming at an alignment key of the second surface of the substrate via the image sensor.

8. The laser cutting method as claimed in claim 7, wherein the alignment key of the first surface of the substrate and the alignment key of the second surface of the substrate are a same alignment key.

9. The laser cutting method as claimed in claim 1, wherein the step of processing the first alignment procedure via the image sensor is practiced by aiming at an alignment key of the first surface of the substrate via the image sensor, and the step of processing the second alignment procedure via the image sensor is practiced by aiming at a shading area of the first cutting channel cut out on the first surface of the substrate via the image sensor where the shading area is a shade revealing area of the first cutting channel on the second surface of the substrate.

10. The laser cutting method as claimed in claim 1, wherein the substrate is fixed on the base via vacuum suction.

11. The laser cutting method as claimed in claim 1, wherein the substrate is fixed on the base via fixing pieces.

12. A laser cutting apparatus used for forming a cutting channel on a substrate, comprising:
a base, the substrate fixed on and disposed at the base;
an image sensor disposed above the base, and the image sensor corresponding to the substrate;
a laser generation unit disposed between the base and the image sensor, and the laser generation unit outputting laser beams;
an optical component set disposed at an output side of the laser beams of the laser generation unit, the optical component set comprising a reflector and a focal convergent lens, and the reflector reflecting the laser beams to the focal convergent lens and then the focal convergent lens outputting the laser beams to the substrate; and
a control unit disposed at one side of the base, and the control unit electrically connected to the image sensor and the laser generation unit.

13. The laser cutting apparatus as claimed in claim 12, wherein the base comprises a moving member, and the image sensor is connected to the moving member.

14. The laser cutting apparatus as claimed in claim 12, wherein the image sensor is correspondingly equipped with a reflector, and the reflector reflects images of the substrate to the image sensor.

15. The laser cutting apparatus as claimed in claim 12, wherein the base is a platform to be seen through, a second moving member is comprised and disposed below the base, and a second image sensor is disposed below the base, the second image sensor is connected to the second moving member, and the second image sensor is electrically connected to the control unit.

16. The laser cutting apparatus as claimed in claim 12, wherein the base comprises a groove, and the substrate is placed in the groove.

17. The laser cutting apparatus as claimed in claim 12, wherein the base comprises and is installed with fixing pieces, and the substrate is fixed between the fixing pieces and the base.

18. The laser cutting apparatus as claimed in claim 12, wherein the base is equipped with a vacuum system, and the substrate is fixed on the base via vacuum suction.
